(19) United States
(12) Patent Application Publication
(10) Pub. No.: US 2026/0320735 A1
(43) Pub. Date: Oct. 15, 2026

(54) ANISOTROPY CODING FOR RENDERING PRIMITIVES

(71) Applicant: Nokia Technologies Oy, Espoo (FI)

(72) Inventors: Daniele MARI, Antwerp (BE); Patrice RONDAO ALFACE, Antwerp (BE)

(21) Appl. No.: 19/633,243

(22) Filed: Mar. 30, 2026

Related U.S. Application Data
(60) Provisional application No. 63/786,582, filed on Apr. 10, 2025.

(51) Int. Cl. G06T 3/40; G06T 3/60

(52) U.S. Cl. CPC G06T 3/40; G06T 3/60

(57) ABSTRACT

An apparatus including a processor and a memory storing instructions that, when executed with the processor, cause the apparatus to perform: receiving one or more rendering primitives and one or more encoding parameters, applying a sort function to at least one first attribute associated with one of the one or more rendering primitives, applying a data transformation to at least one second attribute associated with the one of the one or more rendering primitives based at least in part on the sort function, and forming at least one bitstream comprising the at least one first attribute and the at least one second attribute. Instructions cause an apparatus to perform extracting a first and second attribute associated with a rendering primitive from a bitstream and reconstructing a representation of the rendering primitive based on metadata.

### TECHNICAL FIELD

The example and non-limiting embodiments relate generally to volumetric frame rendering and, more particularly, to sorting scales attributes of rendering primitives of a volumetric frame rendering.

### BRIEF DESCRIPTION OF PRIOR DEVELOPMENTS

There are many ways to capture and represent a volumetric scene. The format used to capture and represent a volumetric scene depends on the processing to be performed on it, and the target application using it.

A volumetric frame can be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors)

A volumetric frame can be represented as images, with or without depth, captured from multiple viewpoints in 3D space. In other words, the volumetric frame can be represented by one or more view frames where a view is a projection of a volumetric scene on to a plane (the camera plane) using a real or virtual camera with known/computed extrinsic and intrinsic values. Each view may be represented by a number of components (e.g. geometry, color, transparency, and occupancy picture), which may be part of the geometry picture or represented separately.

A volumetric frame can be represented as a mesh. Mesh is a collection of points, called vertices, and connectivity information between vertices, called edges. Vertices along with edges form faces. The combination of vertices, edges and faces can uniquely approximate shapes of objects.

A volumetric frame can be represented as a radiance field, i.e., a representation of rays of light in the scene (sometimes referred to as the plenoptic function or light fields etc.), that can be captured for example by multiple viewpoints such as provided by a number of light field cameras or a number of omnidirectional or plenoptic cameras. Several radiance field representations are described in the following.

A volumetric frame can be represented as an implicit and learned neural radiance field such as the Neural Radiance Field (NeRF) representation for example. A NeRF is a representation of a 3D scene that is parameterized by a deep neural network (DNN). The network predicts a volume density and view-dependent emitted radiance given the spatial location (x, y, z) and viewing direction, e.g., in Euler angles (θ, φ, ψ) of the camera. Volume rendering techniques can produce an image by sampling points along rays intercepted by the camera projection model.

A volumetric frame can be represented as a learned radiance field such as the Gaussian Splatting (a.k.a., 3DGS, 4DGS, Gaussian Splat) representation. This representation can be seen as a point cloud representation with additional attributes that model the geometry and appearance of the scene in the close neighborhood of a position (x, y, z). Rendering of radiance fields represented as Gaussian splats and other variants using modified versions of the attributes may be performed by simple and fast rasterization or more accurate volume rendering using ray tracing.

Depending on the capture, a volumetric frame can provide viewers the ability to navigate a scene with six degrees of freedom, i.e., both translational and rotational movement of their viewing pose (which includes yaw, pitch and roll). The data to be coded for a volumetric frame can also be significant, as a volumetric frame can contain large numbers of objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression.

### SUMMARY OF THE INVENTION

The following summary is merely intended to be an example. The summary is not intended to limit the scope of the claims.

In accordance with one aspect, apparatus is provided comprising: at least one processor; and at least one memory storing instructions that, when executed with the at least one processor, cause the apparatus to perform: (i) receiving one or more rendering primitives and one or more encoding parameters, (ii) applying a sort function to at least one first attribute associated with one of the one or more rendering primitives, (iii) applying a data transformation to at least one second attribute associated with the one of the one or more rendering primitives based at least in part on the sort function, and (iv) forming at least one bitstream comprising the at least one first attribute and the at least one second attribute.

In accordance with one aspect, apparatus is provided comprising: at least one processor; and at least one memory storing instructions that, when executed with the at least one processor, cause the apparatus to perform: (i) receiving at least one bitstream, the at least one bitstream comprising one or more rendering primitives and metadata associated with the one or more rendering primitives, (ii) extracting at least one first attribute and at least one second attribute associated with at least one of the one or more rendering primitives based at least in part on the metadata associated with the one or more rendering primitives, and (iii) determining an output of the at least one of the one or more rendering primitives by associating the at least one first attribute and the at least one second attribute with at least one third attribute of the at least one of the one or more rendering primitives.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 illustrates an example point cloud (e.g., a Gaussian Splat) in accordance with example embodiments of the disclosure;

FIGS. 3A and 3B illustrate example spherical harmonics (FIG. 3A) and a visual comparison with DCT basis functions (FIG. 3B) in accordance with example embodiments of the disclosure;

FIGS. 4A-4C illustrate example ellipsoids in accordance with example embodiments of the disclosure;

FIGS. 5A-5C illustrate example ellipsoids in accordance with example embodiments of the disclosure;

FIGS. 6A and 6B illustrate example encoder flowcharts in accordance with example embodiments of the disclosure;

FIG. 7 illustrates an example decoder flowchart in accordance with example embodiments of the disclosure; and

FIGS. 8 and 9 illustrate example flow diagrams in accordance with one or more example embodiments of the disclosure.

### DETAILED DESCRIPTION

The following abbreviations that may be found in the specification and/or the drawing figures are defined as follows:
DCT Discrete Cosine Transform
G-PCC ISO/IEC 23090-9 Geometry based Point Cloud Compression
GS Gaussian Splat
KL divergence Kullback-Leibler divergence
LOD Level of Detail
LUT Look Up Table
RAHT Region-Adaptive Hierarchical Transform
SEI Supplemental Enhancement Information

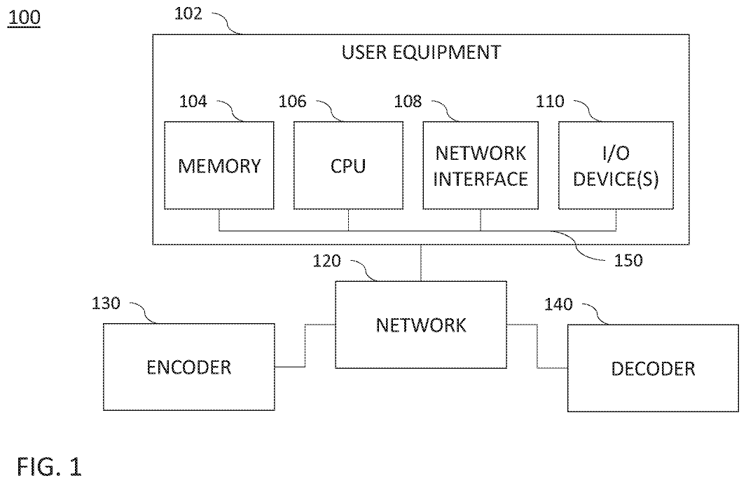

Turning to FIG. 1, this figure shows a block diagram 100 of one possible and non-limiting example in which the examples may be practiced. A user equipment (UE) 102, an encoder device 130, a decoder device 140, and a network 120 are illustrated. Examples of network equipment, network device, or a network entity might be understood to include, at least part of, a transmission reception point or a cell or a gNB or node for example. In the example of FIG. 1, the user equipment (UE) 102 may be in wireless communication with a wireless network 120. A UE may be a wireless device that can access the wireless network 100. The UE 102 includes one or more processors 106, one or more memories 104, one or more network interfaces 108, and one or more input/output device interfaces 110 interconnected through one or more buses 150. Each of the one or more network interfaces 108 may include a receiver, Rx, and a transmitter, Tx. The one or more buses 150 may be address, data, or control buses, and may include any interconnection mechanism, such as a series of lines on a motherboard or integrated circuit, fiber optics or other optical communication equipment, or the like. The one or more network interfaces 108 may be connected to one or more antennas. The one or more memories 104 may include computer program code. The UE 102 may include one or more modules. The modules 140 may be implemented in hardware, such as being implemented as part of the one or more processors 106. The module may be implemented also as an integrated circuit or through other hardware such as a programmable gate array. In another example, the module may be implemented as computer program code and may be executed by the one or more processors 106. For instance, the one or more memories 104 and the computer program code may be configured to, with the one or more processors 106, cause the user equipment 102 to perform one or more of the operations as described herein. The UE 102 may communicate with other user equipment (e.g., additional instantiations of UE 102) via wired or wireless network 120. Encoder 130 or Decoder 140 may include some, all, or additional features described in conjunction with UE 102. For example, Encoder 130 or Decoder 140 may be example instantiations of UE 102. In some embodiments, a UE 102 may have encoding and decoding capabilities as described herein.

The network 120 may include a network element or elements that may include core network functionality, and which provides connectivity via a link or links with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s), and note that both 5G and LTE functions might be supported.

The network 120 may be a wireless network configured to implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors and memories, and also such virtualized entities create technical effects.

The computer readable memories 104 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 104 may be means for performing storage functions. The processors 106 may be of any type suitable to the local technical environment, and may include one or more of general purpose computers, special purpose computers, microprocessors, digital signal processors (DSPs) and processors based on a multi-core processor architecture, as non-limiting examples. The processors 106 may be means for performing functions, such as controlling the UE 102, encoder device 130, decoder device 140, and other functions as described herein.

In general, the various embodiments of the user equipment 102 may include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

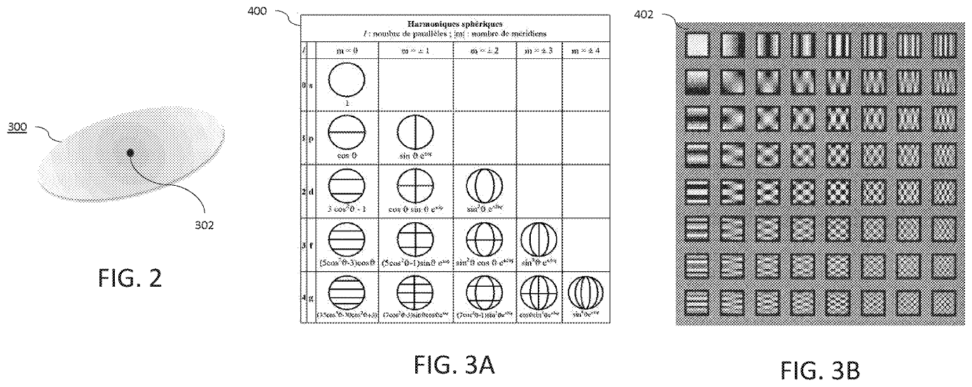

Gaussian splats may be seen as point clouds with additional attributes as illustrated in FIG. 2.
Attributes of the Gaussian Splats include:
   Position (x,y,z)
   Scale (sx,sy,sz); i.e., non-uniform scale factor of the Gaussian splat
   Rotation (rx,ry,rz) or (qx,qy,qz,qw); i.e., the rotation of the Gaussian splat with respect to world coordinates, the rotation is expressed by Euler angles or quaternions
Optionally, Normal (nx, ny, nz); i.e., the normal vector of the Gaussian splat
   Opacity (alpha), i.e., a factor that indicates the transparency of the Gaussian splat
   Color (r,g,b), i.e., the primary color of the Gaussian splat
Spherical harmonics (e.g. SH [0:48]), i.e., the reflectance of the Gaussian splat expressed in spherical harmonics

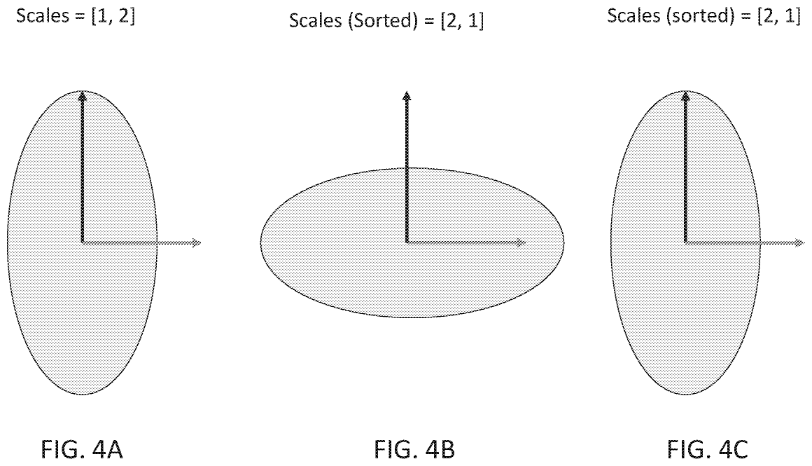

In some embodiments, color is represented by the DC component of spherical harmonics, and spherical harmonics contain 45 non-DC components. Spherical harmonics can be seen as DCT basis functions defined on the sphere (see FIG. 3).

The rendering function for a Gaussian splat is as follows:

$${g}_{i} ( p ) = α exp ( - \frac{1}{2} ( p - {μ}_{i} ) {\sum }_{i}^{- 1} ( p - {μ}_{i} ) )$$

Where Σ is the covariance matrix and is equal to:

Σ=RSS^{T}R^{T}

Where R is a 3×3 rotation matrix expressed with 4 quaternions and S is a diagonal scaling matrix with 3 parameters for scale.

FIG. 2 illustrates an example Gaussian Splat 200. The position information is the one of its center highlighted by a circle 202. The size and orientation of the shape of splat 200 may be determined by, for example, scale and rotation. The color, transparency and reflectivity may be defined by the spherical harmonics and opacity.

FIG. 3A illustrates example Spherical Harmonics 300. FIG. 3B illustrates a visual comparison with DCT basis functions in 302. Similarly to DCT that enables low to high frequency variations on the horizontal and vertical axis of an image, increasing order of spherical harmonics shows increasing frequency variations in vertical and horizontal directions on the sphere. The first component (m=0, 1=0), referred to as DC represents a constant value over the sphere, the second component (m=0, 1=1) enables a variation from south pole to north pole following cos (theta), the third component enables a variation from one side of the equator to the other side, etc. Multiplying the three color components RGB to these 15 basis functions on the sphere leads to 45 spherical harmonics components as illustrated in FIGS. 3A and 3B. Some approaches achieve a fast estimation of the Spherical harmonics transform and inverse transform by relying on the FFT.

Other variants of radiance fields representations may include:
Spherical point clouds, which are similar to Gaussian splats except that the shape is spherical, i.e., there is only one scale factor and there is no rotation attribute data and no falloff due to the gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats but the rendering equation is defined on a rectangle
DGS or surfels, similar to Gaussian splats but where the smallest scale is set to zero and a normal is defined. These are typically defined on surfaces in the tangent space. The rendering equation is the same as for Gaussian splats
Gaussian splats with neural appearance attributes, where view dependent appearance is represented by latent variables. The rendering equation requires a MLP to decode the latent appearance

Some variants of Gaussian splats do not explicitly encode a unique center position with extra attributes, but do not prevent from coding or deriving such center position. For example, billboards of Gaussian Textures describe a rectangular tile on which the Gaussian splat representation is defined instead of a single central point. Another example is 3D Convex Splatting (3DCS) that encode a polygonal shape containing N points without encoding any central position. Nevertheless, the appearance attributes are similar to 3DGS as well as the rendering and learning strategy used to model those from input camera views.

Gaussian splats may be coded using different formats. An example of a coding format that is available for Gaussian splat coding is a .spz file format for static Gaussian splats. The .spz file format is a gzipped stream of data consisting of a 16-byte header followed by the gaussian data. This data may be organized by attribute in the following order: positions, scales, rotations, alphas, colors, and spherical harmonics.

In some cases, the header may be as follows in Table I in little-endian.

TABLE I

| PackedGaussianHeader ( ) | |
|---|---|
| uint32_t | magic; |
| uint32_t | version; |
| uint32_t | numPoints; |
| uint8_t | shDegree; |
| uint8_t | fractionalBits; |
| uint8_t | flags; |
| uint8_t | reserved; |

Values may, in one example, be specified as follows:
magic: 0x5053474e
version: 2
numPoints: number of encoded gaussians
shDegree: The degree of spherical harmonics. This must be between 0 and 3 (inclusive).
fractionalBits: number of bits used to store the fractional part of coordinates in the fixed-point encoding.
flags: bit field containing flags.
   0x1: whether the splat was trained with antialiasing.
reserved: Reserved for future use. Must be 0.

In some embodiments, positions may be represented as (x, y, z) coordinates, each as a 24-bit fixed point signed integer. The number of fractional bits may be determined by the fractionalBits field in the header. In some embodiments, scales may be represented as (x, y, z) components, each represented as an 8-bit log-encoded integer. Additionally, rotations may be represented as the (x, y, z) components of the normalized rotation quaternion. Further, the w component may be derived from the others and is not stored. Each component may be encoded as an 8-bit signed integer. In some cases, alphas may be represented as 8-bit unsigned integers. Further, colors may be stored as (r, g, b) values, where each color component is represented as an unsigned 8-bit integer.

In some embodiments, depending on the degree of spherical harmonics for the splat, this can contain 0 (for degree 0), 9 (for degree 1), 24 (for degree 2), or 45 (for degree 3) coefficients per Gaussian. Additionally, the coefficients for a gaussian may be organized such that the color channel is the inner (faster varying) axis, and the coefficient is the outer (slower varying) axis, i.e. for degree 1, the order of the 9 values is:
sh1n1_r, sh1n1_g, sh1n1_b, sh10_r, sh10_g, sh10_b, sh1p1_r, sh1p1_g, sh1p1_b

Each coefficient may be represented as an 8-bit signed integer. Further, additional quantization may be performed to attain a higher compression ratio. This library may, for example, use five bits of precision for degree 0 and four bits of precision for degrees 1 and 2.

In some embodiments, G-PCC may be used to encode arbitrary attributes. An extension of G-PCC requires a simple modification to code quaternions and add the required metadata for pre- and post-processing attributes.

The following example notations may be used for current extension of G-PCC for Gaussian Splats in accordance with the disclosed embodiments:
geometry: xyz positions of points
sh0: DC values of the spherical harmonics
sh1: first 3 AC values of the spherical harmonics
sh2: next 5 AC values of the spherical harmonics
sh3: last 7 AC values of the spherical harmonics
opacity: opacity
scale: scale
rotation: rotation

Table II illustrates example G-PCC extension bit allocation per component or attribute for a single primitive.

TABLE II

| Component | # of bits | |
|---|---|---|
| Geometry | 3 × 18 | bits |
| sh0 | 3 × 12 | bits |
| sh1 | 3 × 12 | bits |
| sh2 | 5 × 12 | bits |
| sh3 | 7 × 0 | bits |
| opacity | 1 × 12 | bits |
| scale | 3 × 12 | bits |
| rotation | 4 × 12 | bits |
| Total: | 282 | bits |

In some embodiments, a pre-processing step may be performed to quantize components with specific bit depths that are reported in Table 1. G-PCC may be used to encode positions as point clouds and the additional Gaussian splat attributes may, for example, be encoded with (Region-Adaptive Hierarchical Transform) RAHT.

With respect to bitstream signaling in embodiments disclosed herein, similar terminology for encoding syntax as ISOIEC 23090-5 may be used. For example, u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with the most significant bit written first. When n is equal to 0, the associated syntax element is not present in the bitstream and its corresponding value shall be inferred to be equal to 0 unless specified otherwise in the semantics. In another example, ue(v): unsigned integer 0-th order Exp-Golomb-coded syntax element with the left bit first.

For purposes of this disclosure, a “rendering primitive” will refer to Gaussian Splats and their variants. Other terms may be used interchangeably, such as “representative primitive” or “radiance field representation.” Rendering primitives may support anisotropy so that Gaussian splats can stretch and orient themselves differently in space. To do so, rendering primitives may, for example, be parametrized with rotation and scale parameters (e.g., 3D gaussians, 3D ellipsoids, 3D parallelepiped). In some embodiments, data compression methods are described for various parameters of rendering primitives, such as the rotation and scale parameters.

In some embodiments, a rendering primitive may be a geometric object that can be used for rendering and it may be characterized by a position in a N-dimensional space. Additionally, a rendering primitive may be characterized by geometric attributes, such as the scales and the rotations for an ellipsoid or a Gaussian, or the dimensions and rotation of a rectangle, cube, plane, hypercube, or the like. Additionally, or alternatively, a rendering primitive may be characterized by additional attributes, such as color, representation learned through gradient descent or a neural network, semantic information, material information, or the like. These types of additional attributes may be referred to as non-geometric or appearance attributes. One example of rendering primitive is a 3D Gaussian splat as described herein.

In some embodiments, a set of rendering primitives may include children and parents rendering primitives. Children and parents rendering primitives may define a hierarchical relationship between rendering primitives where the parent may be obtained by aggregating the information of the children. The parent could be the same or a different type of primitive with reference to the children. Additionally, or alternatively, the parent and children rendering primitives might have different attributes.

The present embodiments may relate to, among other things, systems and methods for efficiently sorting and coding scale parameters of rendering primitives by ensuring that the resulting rendering primitives can be rendered exactly like the original. In one example, an encoder device may sort and code scale parameters of a set of rendering primitives of a volumetric representation. Additionally, or alternatively, the encoder device may sort the scale parameters losslessly. A decoder device may receive the sorted and coded scale parameters of the set of rendering primitives via one or more bitstreams, extract the scale parameters, and reconstruct the volumetric representation. Additionally, or alternatively, the one or more bitstreams may include additional information that may be used by the decoder to reconstruct the volumetric representation. For example, the one or more bitstreams may include signaling data that may be extracted by the decoder. Signaling data may include, for example, the primitive type, or types, of the rendering primitives, attribute types, attribute coding procedures, possible geometry coding procedures, possible binarization techniques, and how the rendering primitives were encoded.

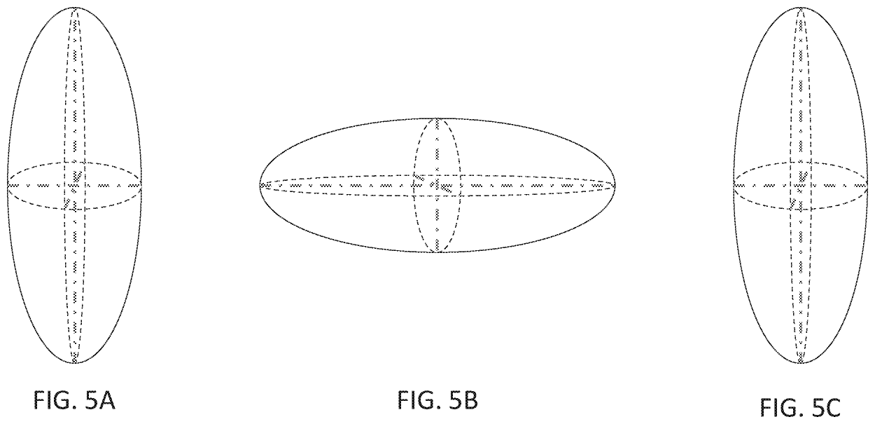

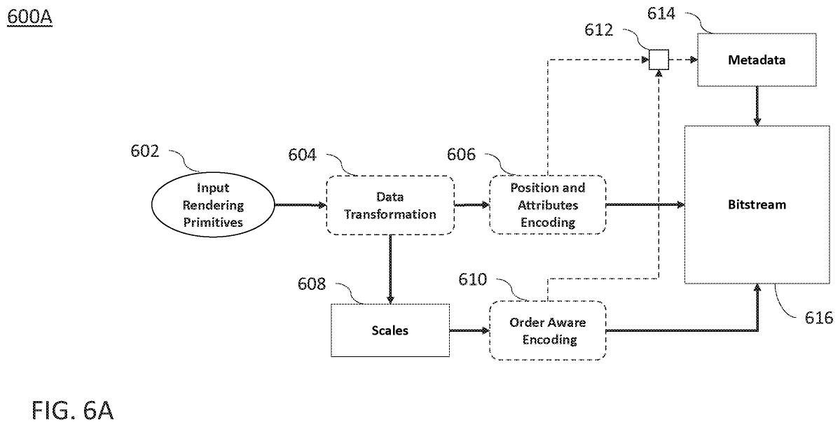

In some embodiments, systems and methods for sorting scale attributes for rendering primitives may have an effect on other attributes of the rendering primitives. For example, in reference to FIGS. 4A-4C and 5A-5C, sorting the scale attribute values may lead to different renderings of a geometric object. In these examples, the scale values are sorted in descending order. FIGS. 4A-4C depict a 2D object, such as a Gaussian splat. FIG. 4A shows an example rendering of a 2D object with a scale of [1, 2]. FIG. 4B shows an example rendering of the 2D object with a sorted scale of [2, 1]. While the scale values have been inverted, the rotation parameter has not been modified. So that the 2D object is rendered properly after the scale attributes are sorted, the rotation attribute of the rendering primitive must be adjusted. In this example, the 2D object should be rotated 90 degrees. After adjusting the rotation attribute of the rendering primitive accordingly, the 2D object is rendered in the same way as the original as shown in FIG. 4C. A second example is depicted in FIGS. 5A-5C which shows an example rendering of a 3D object. In this example, the scale attribute of a rendering primitive, as shown in FIG. 5A is [1, 2, 1]. After sorting, the scale attribute, as depicted by FIG. 5B, is [2, 1, 1]. In this example, the rotation attribute of the rendering primitive must be adjusted by 90 degrees so that the 3D object rendered in FIG. 5C is identical to the original rendered in FIG. 5A. In some embodiments, when two rendering primitives share the same primitive type and parameters except rotation and scales being identical, the two rendering primitives will be rendered the same if their covariance matrix is identical.

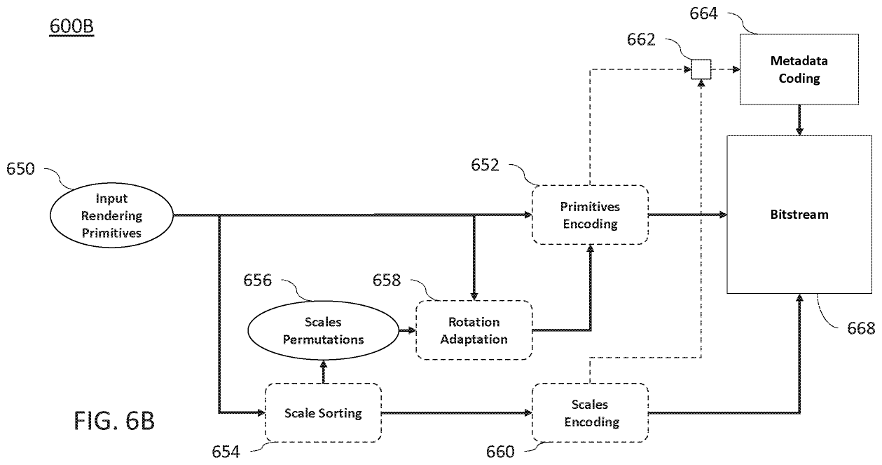

Method 600A of FIG. 6A provides an example encoding procedure for sorting and coding attributes of rendering primitives. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. For example, at 602, method 600A may include receiving as input a set of rendering primitives. Additionally, at 602, method 600A may include receiving one or more coding parameters that may properly define a data transformation procedure.

Method 600A, at 604, may include applying a data transformation to the data leading to scales sorted along the channel dimension. In one example, scale values may be sorted along the channel dimension from the smallest to the largest. In another example, scale values may be sorted from largest to smallest.

In one example, the covariance matrix of rendering primitives may be obtained from the input 602 or it may be computed from the scale and rotation attribute values of input 602. For the latter, in one example, scale and rotation values may be obtained by running eigenvalue-eigenvector decomposition of the covariance matrix within most implementations which returns the eigenvalues matrix with the eigenvalues sorted in descending order and corresponding eigenvectors computed accordingly. In this example, the rotation matrix R may be properly defined in a way that RSS\hat{ }T R\hat{ }T is the actual covariance matrix of a rendering primitive.

Computing scale and rotation attribute values from the covariance matrix may be required in some scenarios. For example, computing scale and rotation attribute values from the covariance matrix may be required when the covariance is provided directly as an output of an optimization procedure. In another example, computing scale and rotation attribute values from the covariance matrix may be required when a data transform is applied that requires using the covariance matrix. For example, when aggregating children rendering primitives into a parent rendering primitive, one way to do so is to average the covariance values of the children rendering primitives and adding a covariance component that is dependent in the relative position between the parent position and the children positions. In yet another example, computing scale and rotation attribute values from the covariance matrix may be required when the covariance is computed simply as a way to easily obtain sorted scale values. Additionally, or alternatively, the scale values may be sorted without resorting to eigen decomposition.

In one example embodiment, the scale values may be sorted in descending order by finding the permutation matrix P s.t. s′=Ps with s′ sorted. The matrix P in 3D either represents a 3D rotation or a 3D reflection. In the former case, the rotation matrix may be easily updated by simply computing R′=RPT. This cannot be done if P is a reflection since doing so leads to a matrix R′that is not a rotation matrix because its determinant would be −1. In 3D vectors, there are three such reflections, one per axis, corresponding to permutations [2, 1, 3], [1, 3, 2], [3, 2, 1]. On the other hand, the three permutations that can be parameterized as a rotation matrix are [1, 2, 3], [3, 1, 2], [2, 3, 1]. When handling reflections, the symmetry of the rendering primitive can be exploited. Most rendering primitives, such as Gaussian splats, ellipsoids, and bounding boxes, have planar and/or radial symmetries thus finding a rotation that leads to the same rendering. The rotation that is equivalent, when rendering, to the considered reflection may be obtained as a rotation of 90 degrees around the axis where the reflection is defined. This allows modification of the rotation values and scale values to make sure that the rotations are still valid and that the final rendering primitive leads to the same rendering as before this procedure. This scenario, as mentioned before, is only applicable when the considered rendering primitive has planar symmetries. In some embodiments only the scale values are sorted and the corresponding permutation is assigned as an additional attribute to the primitive.

Continuing with the example, once sorted, method 600A at 604, provides the transformed attributes of the rendering primitives, in this example the scale values, as scales 608. The transformed attributes of the rendering primitives may include scale values that are sorted along the channel dimension. Additionally, method 600A, at 604, generates metadata that may be provided as output. The metadata may, in some cases, explain the steps carried out during the transformation of the scale values. The generated metadata may be aggregated by method 600A at 612.

Method 600A, at 606, may include encoding of the position and other attributes associated with each rendering primitive of a set of rendering primitives. Encoding of the position of the rendering primitive may, as described herein, including encoding the coordinates of a geometric shape. In one example embodiment, when the geometric shape is a Gaussian splat, the splat's position may be defined using x, y and z coordinates of an x-axis, y-axis and a z-axis, respectively. Additional attributes of the rendering primitive that may be encoded at 606 may include, for example, opacity, color, spherical harmonics, or the like. Method 600A, at 606, may include generating metadata that signals information pertaining to the encoded position data and the encoded attribute data of the rendering primitive. The generated metadata may be aggregated by method 600A at 612.

Method 600A, at 610, may include order aware encoding of sorted scales 608. The sorted scales may be provided via bitstream 616. The sorted scales may be compressed and encoded using different encoding schemes, such as ones provided by context-adaptive binary arithmetic coding (CABAC). Two binarization schemes that may be used for encoding include fixed length binarization and exponential-Golomb, or exp-Golomb code. Fixed length binarization may be used when symbols are approximately uniformly distributed. Given S symbols, fixed length binarization assigns to each of the binary string of [log 2S] bits. Exp-Golomb code is a binarization technique that may be used and is optimal for geometrically distributed sources. For exp-Golomb coding, a value x exp-Golomb code is obtained by concatenating its suffix, for example the binary representation of x, with its suffix, for example a string of zeros as long as the binary representation of x minus 1.

In some embodiments, knowing that some attributes may be sorted along their channels provides strong prior information that may be used to effectively encode and decode the data. In one example, the scale values may be encoded starting from the biggest, the first channel may be encoded as-is in one embodiment using GZIP. In another embodiment, the first channel may be encoded using RAHT. In yet another embodiment, the first channel may be encoded using a predictive transform. Additionally, or alternatively, the first channel may be coded using CABAC.

Continuing with the example, the second scale channel may be encoded differentially. Iin particular this allows knowing that s₍ᵢ₋₁₎≥sᵢ≥0 which allows assigning probabilities equal to 0 to all symbols that outside this range when coding sᵢ. The same procedure may be repeated for all the following channels.

In one example embodiment, the residual r=s₍ᵢ₋₁₎−sᵢ may be entropy coded with CABAC using a fixed-length binarization scheme with S=2^{ScaleBitDepth}−└s₍ᵢ₋₁₎/2^{d}┘2^{d} using, for example, └s₍ᵢ₋₁₎/2^{d}┘ as context where the 2^{d} factor (fixed or encoded in or along the bitstream) that can be used to limit the number of possible contexts.

In another embodiment an Exp-Golomb code may be used instead of the Fixed Length Binarization code using as context └s₍ᵢ₋₁₎/2^{d} ┘.

In another embodiment a combination of Exp-Golomb code and fixed length codes may used where the Exp-Golomb code may be used to encode the most significant k bits while the Fixed Length Binarization may be used to code the least significant ScaleBitDepth-k bits. In this case the entropy coding with Exp-Golomb code can use as context └s₍ᵢ₋₁₎/2^{d} ┘ while the Fixed Length Code can use a combination of └s₍ᵢ₋₁₎/2^{d}┘ and k.

In another embodiment the ordering information may be exploited in the coding of the AC coefficients of transforms such as RAHT or Predictive/Lifting transforms. At every hierarchical level, due to the properties of the transform, the DC components may also be sorted the same way the scale values were sorted. This allows restricting the possible values of the AC components for that level since they cannot lead to DC values that are sorted differently at the next level effectively introducing bounds on the possible AC values.

In particular, given two coefficients a=[a₁, a₂, a₃], b=[b₁, b₂, b₃] with weights w₁, w₂, then RAHT computes the AC and DC components as

$$\begin{matrix}DC \\ AC\end{matrix} = \frac{1}{√ ( {w}_{1} + {w}_{2} )} [ \begin{matrix}√ {w}_{1} & √ {w}_{2} \\ - √ {w}_{2} & √ {w}_{1}\end{matrix} ] \begin{matrix}a \\ b\end{matrix}$$

Then since the AC component can be written as

$$\frac{- \sqrt{{w}_{2}} a + \sqrt{{w}_{1}} b}{√ ( {w}_{1} + {w}_{2} )}$$

it is possible to see for example that without any prior the possible value range for the AC component would be [−2^{ScaleBitDepth}, 2^{ScaleBitDepth}] while with the sorting prior once the previous channel has been decoded it is possible to know that the range becomes aᵢ₋₁-bᵢ₋₁ restricting the possible ranges of symbols that can be taken by the AC component. In this case in one embodiment the AC symbol for channel i∈{2, 3} may be coded using a fixed length code with context

$$[ \frac{{a}_{i - 1}}{{2}^{d}} , \frac{{b}_{i - 1}}{{2}^{d}} ] .$$

In another example embodiment, the sign of the AC component may be encoded using as context [−aᵢ₋₁, bᵢ₋₁] which would allow to build different entropy models based on how likely it is that the AC component is positive. The absolute value of the AC component could be then entropy coded using Golomb-exp using as context the sign and the limit of the range in the direction of the sign (e.g., aᵢ₋₁ if the sign is a minus, bᵢ₋₁ if the sign is a plus). Other contexts may be designed and optimized along the lines of these example embodiments. Similar embodiments may also be easily derived for other transforms such as the predictive and lifting transforms.

In an example embodiment where the permutation is associated with the rendering primitive, its value may be encoded in or along the bitstream by representing its value with a symbol from 0 to 5 as there are six total permutations on an array with 3 values. The value representation may be binarized with a fixed length code and encoded using CABAC using as context, for example, the last encoded permutation or the variance of the three scale values (i.e. how similar/different they are).

In another embodiment the representation primitives may be partitioned into six subsets (one corresponding with a different permutation) and the positions may be encoded into six independent substreams. This would allow the decoder to know to which set of primitives a certain permutation should be assigned and then the positions may be re-sorted (for example, according to a Morton ordering) to proceed with the coding of the remaining attributes.

Method 600A, at 612, may include aggregating metadata with respect to the encoding process of the sorted scales 610 and the encoding of the position and other attributes in 606. Method 600A, at 614, may include encoding the aggregated metadata.

Method 600A, at 616, may include forming one or more bitstreams of data that includes the aggregated metadata, the encoded position and attributes, and the encoded sorted scales.

Method 600B of FIG. 6B provides an example encoding procedure for sorting scale attributes, adapting rotation attributes, and coding scale and rotation attributes of rendering primitives. The method may be implemented by a processor of an encoding device. For example, at 650, method 600B may include receiving as input a set of rendering primitives.

Method 600B, at 654, may include applying a data transformation to the data leading to scales sorted along the channel dimension. In one example, scales may be sorted along the channel dimension from the smallest to the largest. Alternatively, scales may be sorted along the channel dimension from the largest to the smallest. Once sorted, the scales may be provided as scales 608. Method 600B, at 658, may include adapting the rotation of rendering primitives based on scales permutations 656 that were provided as output from scale sorting 654. Method 600B, at 652, may include encoding of the position and other attributes associated with each rendering primitive of a set of rendering primitives. Attributes encoded at 652 may include attributes of input rendering primitives 650 and adapted rotation attributes of 658. Method 600B, at 660 may include encoding the sorted scale attributes of the input rendering primitives 650. Method 600B, at 662, may include aggregating metadata with respect to the encoding process of the sorted scales 660, adapted rotation attributes of 658 and the encoding of the position and other attributes in 652. Method 600B, at 664, may include encoding the aggregated metadata. Method 600B, at 668, may include forming one or more bitstreams of data that includes the aggregated metadata, the encoded position and attributes, and the encoded sorted scales.

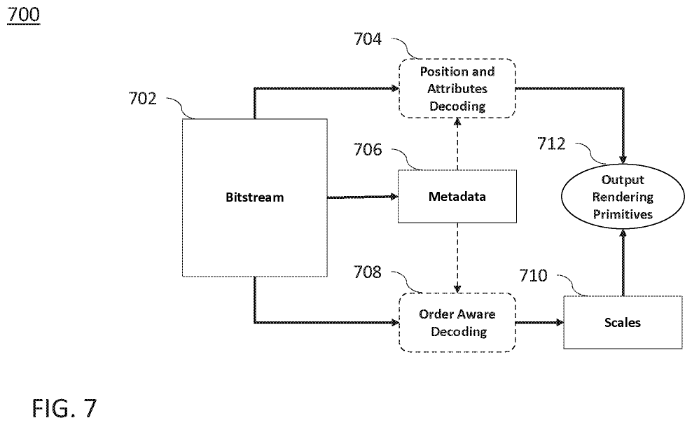

Method 700 of FIG. 7 provides an example decoding procedure for decoding sorted scale attributes, adapted rotation attributes, and other attributes of rendering primitives so that the rendering primitives may be reconstructed. For example, the rendering primitives may be reconstructed to provide a rendering of a volumetric representation of an object. The method may be implemented by a processor of a decoding device. In an example embodiment, the decoding device may be decoder 140 that receives one or more bitstreams from encoder 130 via network 120 shown in FIG. 1. In some embodiments, decoder 140 may be an instance of user equipment 102 that includes a memory 104, a CPU 106, a network interface 108, and I/O devices 110.

Method 700, at 702, may include receiving one or more bitstreams of data. The one or more bitstreams may, at least in part, be encoded bitstreams generated by one or more encoding schemes described herein with respect to FIGS. 6A and 6B.

Method 700, at 704 may include decoding the one or more bitstreams of data to extract positional data and attribute data of one or more rendering primitives. The decoders used at 704 may, in some instances, correspond to the encoders that were used to encode the data, as described herein with respect to FIGS. 6A and 6B. For example, in one non-limiting embodiment, the position data may have been encoded using a G-PCC octree encoding scheme. In another embodiment. the position data may have been encoded using a V-PCC encoding scheme. In yet another embodiment, attributes of the one or more rendering primitives may have been encoded using RAHT. Additionally, or alternatively, attributes of the one or more rendering primitives may have been encoded using Predictive or Lifting transform. In some embodiments, metadata 706 may be extracted by the decoder from bitstream 702 wherein metadata 706 signals not only the primitive type of the one or more rendering primitives, but also the type of encoding schemes used to encode the one or more rendering primitives.

Method 700, at 708 may include decoding the one or more bitstreams of data to extract scale values 710 of the one or more rendering primitives. In some embodiments, metadata 706 may be extracted by the decoder from bitstream 702 wherein metadata 706 signals and indicates how the scale values may have been sorted by the encoder device. The decoding procedure at 708 may correspond to the chosen encoding procedure that will be run at the decoder side. For the example, the decoder may start decoding and it will use the appropriate CABAC binarizers and contexts to be able to decode either the scale values directly or the AC coefficients of a transform. In the embodiment where the permutation applied to the scale is encoded in or along the bitstream, then the permutation may be decoded and its inverse may be applied to the decoded scales to make sure that the primitives are correctly rendered at 712.

In one example embodiment, the positions may be encoded into six independent substreams. The substreams may be decoded independently and the corresponding permutation may be assigned to each of them. The positions and permutations may be sorted according to the same order used to encode the rest of the attributes (e.g. according to Morton ordering).

Method 700, at 712, may output and reconstruct the one or more rendering primitives once the position data, attribute values, and scale values for the one or more rendering primitives are known.

In some example embodiments, metadata may be signaled from the encoder device to a decoder device to enable the decoder device to reconstruct one or more rendering primitives and properly render content. In an example embodiment, the encoder device may be encoder 130 and the decoder device may be decoder 140 wherein encoder 130 and decoder 140 may communicate over a network, such as network 120, all shown in FIG. 1. In some embodiments, encoder 130 or decoder 140 may be an instance of user equipment 102 that includes a memory 104, a CPU 106, a network interface 108, and I/O devices 110.

In some embodiments, the type of rendering primitive may be signaled in the metadata to be encoded into or extracted from the bitstream. Table A details the primitive types.

TABLE A

| primitive_type Index | Primitive type |
|---|---|
| 0 | 3D Gaussian Splat |
| 1 | 2D Gaussian Splat |
| 2 | Ellipsoids |
| 3 | Generalized Gaussians |
| 3 . . . 15 | RESERVED |

The type of attributes may be signaled for the rendering primitive as detailed in Table B.

TABLE B

| Attribute | | |
|---|---|---|
| types | | |
| index | Identifier | Attribute type |
| 0 | ATTR_POSITION | Position |
| 1 | ATTR_ROTATION | Rotation |
| 2 | ATTR_SCALE | Scale |
| 3 | ATTR_BOX | Box |
| 4 | ATTR_RADIUS | Radius |
| 5 | ATTR_COLOR | Color |
| 6 | ATTR_OPACITY | Opacity |
| 7 | ATTR_SPHERICAL_{—} | Spherical |
| | HARMONICS_BAND_1 | Harmonics |
| | | Band 1 |
| 8 | ATTR_SPHERICAL_{—} | Spherical |
| | HARMONICS_BAND_2 | Harmonics |
| | | Band 2 |
| 9 | ATTR_SPHERICAL_{—} | Spherical |
| | HARMONICS_BAND_3 | Harmonics |
| | | Band 3 |
| 10 . . . 14 | ATTR_RESERVED | Reserved |
| 15 | ATTR_UNSPECIFIED | Unspecified |

The possible attribute coding procedures may be signaled for the rendering primitive as detailed in Table C.

TABLE C

| Attribute | | |
|---|---|---|
| coding | | |
| procedure | | Attribute coding |
| index | Identifier | procedure |
| 0 | RAHT | RAHT |
| 1 | DIRECT_ENTROPY_CODING | Direct entropy coding |
| 2 | DIFFERENTIAL_CODING | Differential coding |
| 3 | PREDICTIVE_TRANSFORM | Predictive transform |
| 4 | LIFTING_TRANSFORM | Lifting transform |
| 5 . . . 14 | RESERVED | Reserved |
| 15 | UNSPECIFIED | Unspecified |

The possible geometry coding procedures may be signaled for the rendering primitive as detailed in Table D.

TABLE D

| Geometry | | |
|---|---|---|
| coding | | |
| procedure | | |
| index | Identifier | Geometry coding procedure |
| 0 | GPCC | G-PCC |
| 1 | PCL | Point Cloud Library |
| 2 | DIRECT_CODING | Direct Coding |
| 3 . . . 6 | RESERVED | Reserved |
| 7 | UNSPECIFIED | Unspecified |

The possible binarization techniques may be signaled for the rendering primitive as detailed in Table E.

TABLE E

| Binarization | | |
|---|---|---|
| technique | | |
| index | Identifier | Binarization technique |
| 0 | FLB | Fixed Length Binarization |
| 1 | EXP_GOLOMB | Exp-Golomb code |
| 2 | SIGNED_EXP_GOLOMB | Sign with FLB, Exp- |
| | | Golomb for absolute |
| | | value |
| 3 | EXP_GOLOMB_FLB | Exp-Golomb for most |
| | | significative bits, FLB |
| | | for least significative |
| | | ones |
| 4 . . . 7 | RESER VED | Reserved |

Example metadata describing how the rendering primitives were encoded is shown in Table F.

TABLE F

| | |
|---|---|
| primitive_type | u(4) |
| num_attributes | u(4) |
| geometry_coding_procedure | u(3) |
| geometry_bit_depth | |
| For(i=0; i<num_attributes; i++){ | |
| attribute_type | u(4) |
| bit_depth | ue(v) |
| is_sorted | u(1) |
| attribute_coding_procedure | u(4) |
| If(is_sorted){ | |
| encode_permutations | u(1) |
| sorting_order_is_ascending | u(1) |
| binarization_technique | u(3) |
| If(binarization_technique == EXP_GOLOMB_FLB){ | |
| num_significant_bits | ue(v) |
| } | |
| } | |
| } | |

### Key Definitions

primitive_type: type of the primitives that are encoded, see a set of possible values in table A.

num_attributes: the number of attributes encoded for each primitive

geometry_coding_procedure: the procedure used to code the position of the primitive, a set of possible values can be seen in table D.

geometry_bit_depth: the bit depth used to represent each coordinate of the position of the primitive.

attribute_type: the type of attribute being encoded, a set of possible values can be seen in table B.

bit_depth: the bit depth used to represent each channel of the considered attribute.

is_sorted: a flag saying if the values in the different channels of the considered attribute are sorted.

attribute_coding_procedure: the chosen attribute coding procedure for the considered attribute, a list of possible values can be found in Table C.

encode_permutation: if true then the permutation applied to the scale to sort them is encoded in or along the bitstream.

sorting_order_is_ascending: a flag saying if the attribute is sorted in ascending or descending order

binarization_technique: the chosen binarization technique used to encode the data or the AC components with CABAC, a list of possible values can be found in Table E.

num_significant_bits: Number of most significant bits represented with Exp-Golomb codes when using as binarization technique a combination of Exp-Golomb and fixed length binarization

The following examples are provided and described herein.

In accordance with one aspect, an example apparatus is provided comprising: at least one processor; and at least one memory storing instructions that, when executed with the at least one processor, cause the apparatus to perform: receiving one or more rendering primitives and one or more encoding parameters, applying a sort function to at least one first attribute associated with one of the one or more rendering primitives, applying a data transformation to at least one second attribute associated with the one of the one or more rendering primitives based at least in part on the sort function, and forming at least one bitstream comprising the at least one first attribute and the at least one second attribute.

Additionally, the apparatus may be caused to perform: encoding the at least one first attribute and the at least one second attribute, wherein the at least one bitstream is formed further to comprise the encoded first and second attribute.

In accordance with the example embodiment, the at least one first attribute is scale.

In accordance with the example embodiment, the at least one first attribute is represented as (x,y,z) components.

In accordance with the example embodiment, the sort function sorts the at least one first attribute along a channel dimension.

In accordance with the example embodiment, the sort function sorts the at least one first attribute in descending order.

In accordance with the example embodiment, the at least one second attribute is rotation.

In accordance with the example embodiment, the at least one second attribute is represented as (x,y,z) components.

In accordance with the example embodiment, a covariance matrix is computed based at least in part on the at least one first attribute and the at least one second attribute.

Additionally, the apparatus may be caused to perform: aggregating metadata based on the at least one first attribute and the at least one second attribute, wherein the at least one bitstream is formed further to comprise the aggregated metadata.

Additionally, the apparatus may be caused to perform: encoding a position attribute of the one of the one or more rendering primitives, wherein the at least one bitstream is formed further to comprise the encoded position attribute of the one of the one or more rendering primitives.

Additionally, the apparatus may be caused to perform: aggregating metadata associated with one or more additional attributes associated with the one of the one or more rendering primitives, wherein the at least one bitstream is formed further to comprise the aggregated metadata associated with the one or more additional attributes.

In accordance with the example embodiment, the one or more additional attributes include dimension, color, representation learned through gradient descent or a neural network, semantic info, material info, appearance, or a combination thereof.

In accordance with the example embodiment, the one of the one or more rendering primitives is a 3D Gaussian splat.

Additionally, the apparatus may be caused to perform: encoding the one or more rendering primitives based at least in part on the one or more encoding parameters, and signaling metadata describing how the one or more rendering primitives were encoded, wherein the at least one bitstream is formed further to comprise the encoded one or more rendering primitives and the metadata describing how the one or more rendering primitives were encoded.

In accordance with the example embodiment, the metadata describing how the one or more rendering primitives were encoded include one or more of metadata includes one or more of primitive type, number of attributes, geometry coding procedure, geometry bit depth, attribute type, bit depth, is sorted flag, attribute coding procedure, encode permutation flag, sorting order is ascending flag, binarization technique, and number of significant bits.

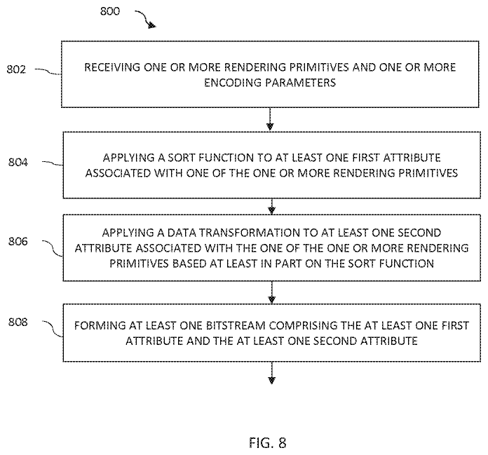

FIG. 8 illustrates an example method 800 of encoding sorted scale attributes of rendering primitives. Method 800 may be implemented by encoder 130 where encoder 130 is an instance of user equipment 102 (all shown in FIG. 1). While FIG. 8 will be discussed in the context of FIG. 1, this is for clarity of explanation purposes only and the method described in FIG. 8 should not be considered limited by the components illustrated in FIG. 1. Method 800 may be implemented by a processor, such as processor 106 of FIG. 1. Method 800, at 802, may include processor 106 receiving one or more rendering primitives and one or more encoding parameters. Method 800, at 804, may include processor 106 applying a sort function to at least one first attribute associated with one of the one or more rendering primitives. Method 800, at 806, may include processor 106 applying a data transformation to at least one second attribute associated with the one of the one or more rendering primitives based at least in part on the sort function. Method 800, at 808, may include processor 106 forming at least one bitstream comprising the at least one first attribute and the at least one second attribute.

In accordance with another aspect, an example apparatus is provided comprising: at least one processor; and at least one memory storing instructions that, when executed with the at least one processor, cause the apparatus to perform: receiving at least one bitstream, the at least one bitstream comprising one or more rendering primitives and metadata associated with the one or more rendering primitives, extracting at least one first attribute and at least one second attribute associated with at least one of the one or more rendering primitives based at least in part on the metadata associated with the one or more rendering primitives, and determining an output of the at least one of the one or more rendering primitives by associating the at least one first attribute and the at least one second attribute with at least one third attribute of the at least one of the one or more rendering primitives.

In accordance with the example embodiment, the output is a volumetric representation rendering of the one or more rendering primitives.

In accordance with the example embodiment, the at least one first attribute is scale.

In accordance with the example embodiment, the at least one first attribute is represented as (x,y,z) components.

In accordance with the example embodiment, the metadata associated with the one or more rendering primitives indicates that the at least one first attribute was sorted along a channel dimension.

In accordance with the example embodiment, the metadata associated with the one or more rendering primitives indicates that the at least one first attribute was sorted in descending order.

In accordance with the example embodiment, the at least one second attribute is rotation.

In accordance with the example embodiment, the at least one second attribute is represented as (x,y,z) components.

In accordance with the example embodiment, a covariance matrix is computed based at least in part on the at least one first attribute and the at least one second attribute.

Additionally, the apparatus may be caused to perform: decoding a position attribute of the one of the one or more rendering primitives from the at least one bitstream.

Additionally, the apparatus may be caused to perform: extracting metadata associated with one or more additional attributes associated with the one of the one or more rendering primitives from the at least one bitstream.

In accordance with the example embodiment, the one or more additional attributes include dimension, color, representation learned through gradient descent or a neural network, semantic info, material info, appearance, or a combination thereof.

In accordance with the example embodiment, the one of the one or more rendering primitives is a 3D Gaussian splat.

In accordance with the example embodiment, the metadata associated with the one or more rendering primitives includes one or more of primitive type, number of attributes, geometry coding procedure, geometry bit depth, attribute type, bit depth, is sorted flag, attribute coding procedure, encode permutation flag, sorting order is ascending flag, binarization technique, and number of significant bits.

In accordance with the example embodiment, orientation of the one of the one or more rendering primitives is determined based on the second attribute.

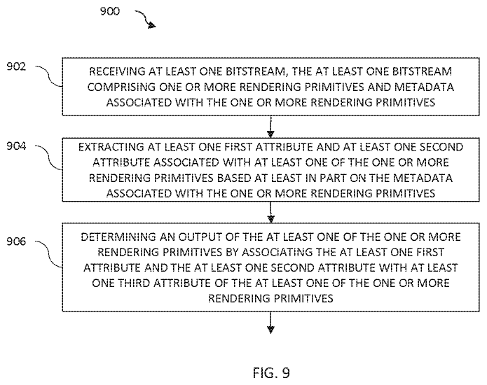

FIG. 9 illustrates an example method 900 of decoding sorted scale attributes of rendering primitives. Method 900 may be implemented by decoder 140 where encoder 140 is an instance of user equipment 102 (all shown in FIG. 1). While FIG. 9 will be discussed in the context of FIG. 1, this is for clarity of explanation purposes only and the method described in FIG. 9 should not be considered limited by the components illustrated in FIG. 1. Method 900 may be implemented by a processor, such as processor 106 of FIG. 1. Method 900, at 902, may include processor 106 receiving at least one bitstream, the at least one bitstream comprising one or more rendering primitives and metadata associated with the one or more rendering primitives. Method 900, at 904, may include processor 106 extracting at least one first attribute and at least one second attribute associated with at least one of the one or more rendering primitives based at least in part on the metadata associated with the one or more rendering primitives. Method 900, at 906, may include processor 106 determining an output of the at least one of the one or more rendering primitives by associating the at least one first attribute and the at least one second attribute with at least one third attribute of the at least one of the one or more rendering primitives.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising: at least one processor; and at least one memory storing instructions that, when executed by the at least one processor, cause the apparatus to perform at least the following: receiving one or more rendering primitives and one or more encoding parameters; applying a sort function to at least one first attribute associated with one of the one or more rendering primitives; applying a data transformation to at least one second attribute associated with the one of the one or more rendering primitives based at least in part on the sort function; and forming at least one bitstream comprising the at least one first attribute and the at least one second attribute.

2. The apparatus of claim 1, further being caused to perform: encoding the at least one first attribute and the at least one second attribute, wherein the at least one bitstream is formed further to comprise the encoded first and second attribute.

3. The apparatus of claim 1, wherein the at least one first attribute is scale.

4. The apparatus of claim 1, wherein the sort function sorts the at least one first attribute along a channel dimension.

5. The apparatus of claim 1, wherein the sort function sorts the at least one first attribute in descending order.

6. The apparatus of claim 1, wherein the at least one second attribute is rotation.

7. The apparatus of claim 1, further being caused to perform:
aggregating metadata based on the at least one first attribute and the at least one second attribute, wherein the at least one bitstream is formed further to comprise the aggregated metadata.

8. An apparatus comprising: at least one processor; and at least one memory storing instructions that, when executed by the at least one processor, cause the apparatus to perform at least the following: receiving at least one bitstream, the at least one bitstream comprising one or more rendering primitives and metadata associated with the one or more rendering primitives; extracting at least one first attribute and at least one second attribute associated with at least one of the one or more rendering primitives based at least in part on the metadata associated with the one or more rendering primitives; and determining an output of the at least one of the one or more rendering primitives by associating the at least one first attribute and the at least one second attribute with at least one third attribute of the at least one of the one or more rendering primitives.

9. The apparatus of claim 8, wherein the at least one first attribute is scale.

10. The apparatus of claim 8, wherein the metadata associated with the one or more rendering primitives indicates that the at least one first attribute was sorted along a channel dimension.

11. The apparatus of claim 8, wherein the metadata associated with the one or more rendering primitives indicates that the at least one first attribute was sorted in descending order.

12. The apparatus of claim 8, wherein the at least one second attribute is rotation.

13. The apparatus of claim 8, wherein a covariance matrix is computed based at least in part on the at least one first attribute and the at least one second attribute.

14. The apparatus of claim 8, further being caused to perform: decoding a position attribute of the one of the one or more rendering primitives from the at least one bitstream.

15. The apparatus of claim 8, further being caused to perform: extracting metadata associated with one or more additional attributes associated with the one of the one or more rendering primitives from the at least one bitstream.

16. The apparatus of claim 8, wherein the metadata associated with the one or more rendering primitives includes one or more of primitive type, number of attributes, geometry coding procedure, geometry bit depth, attribute type, bit depth, is sorted flag, attribute coding procedure, encode permutation flag, sorting order is ascending flag, binarization technique, and number of significant bits.

17. The apparatus of claim 8, wherein orientation of the one of the one or more rendering primitives is determined based on the second attribute.

18. A method comprising: receiving at least one bitstream, the at least one bitstream comprising one or more rendering primitives and metadata associated with the one or more rendering primitives; extracting at least one first attribute and at least one second attribute associated with at least one of the one or more rendering primitives based at least in part on the metadata associated with the one or more rendering primitives; and determining an output of the at least one of the one or more rendering primitives by associating the at least one first attribute and the at least one second attribute with at least one third attribute of the at least one of the one or more rendering primitives.

19. The method of claim 18, wherein the at least one first attribute is scale.

20. The method of claim 18, wherein the at least one second attribute is rotation.
